(19) United States
(12) Patent Application Publication
(10) Pub. No.: US 2022/0357170 A1
(43) Pub. Date: Nov. 10, 2022

(54) ROUTE DISPLAY APPARATUS, ROUTE DISPLAY METHOD, AND NON-TRANSITORY COMPUTER READABLE MEDIUM STORING PROGRAM

(71) Applicant: NEC Corporation, Minato-ku, Tokyo (JP)

(72) Inventors: Kazufumi KOJIMA, Tokya (JP); Masahiro TANI, Tokyo (JP); Keisuke IKEDA, Tokyo (JP)

(73) Assignee: NEC Corporation, Minato-ku, Tokyo (JP)

(21) Appl. No.: 17/619,727

(22) PCT Filed: Jun. 21, 2019
(86) PCT No.: PCT/JP2019/024815

§ 371 Date: Dec. 16, 2021

(51) Int. Cl. G01C 21/34; G01C 21/36; G06Q 50/30

(52) U.S. Cl. CPC G01C 21/3492; G01C 21/3626; G01C 21/3691; G06Q 50/30; G08B 25/04

(57) ABSTRACT

A route display apparatus (10) according to the present disclosure includes: an acquisition unit (11) that acquires friend account information of a friend account that is connected online to an account of interest; a specification unit (12) that specifies a traffic site near an activity site of a friend user who uses the friend account based on the acquired friend account information; a calculation unit (13) that calculates an estimated movement route of a user of interest who uses the account of interest, the estimated movement route including the specified traffic site; and a display unit (14) that displays the calculated estimated movement route.

### TECHNICAL FIELD

The present disclosure relates to a route display apparatus, a route display method, and a non-transitory computer readable medium storing a program.

### BACKGROUND ART

In recent years, Internet services such as Social Networking Services (SNSs) have begun to be widely used throughout the world, and the number of users continues to increase. Consequently, connections between SNS users in a virtual cyberspace (Cyber World, Cyber Space) on the Internet have become complex and diverse, and thus research related to the above has been conducted.

As related technologies, for example, Non Patent Literature 1 and Non Patent Literature 2 are known. Non Patent Literature 1 discloses a network visualization tool which enables the structure of an SNS community to be easily known. Non Patent Literature 2 discloses a method for estimating information about the place of residence of a user using an SNS account based on information about the place of residence of a user having a friend relationship with the former user.

### CITATION LIST

### Non Patent Literature

Non Patent Literature 1: Jeffrey Heer, Danah Boyd (University of California), “Vizster: Visualizing Online Social Networks”, IEEE Symposium on Information
Visualization (InfoVis 05), Oct. 23-25, 2005, Minneapolis, Minn., USA, P. 33-40
Non Patent Literature 2: Lars Backstrom, Eric Sun, Cameron Marlow (Facebook), “Find Me If You Can: Improving Geographical Prediction with Social and Spatial Proximity”, WWW 2010, Apr. 26-30, 2010, Raleigh, N.C., USA, P. 61-70

### SUMMARY OF INVENTION

### Technical Problem

As described above, the related technologies make it possible to know the relationship among friends of an account and estimate a place of residence of a user with a certain degree of accuracy. However, the related technologies have a problem that it is difficult to know an estimated action area of the user in the real world (Real World, Physical Space) related to the account in cyberspace.

In view of the problem described above, an object of the present disclosure is to provide a route display apparatus, a route display method, and a non-transitory computer readable medium storing a program that are capable of knowing an estimated action area of a user.

### Solution to Problem

A route display apparatus according to the present disclosure includes: acquisition means for acquiring friend account information of a friend account that is connected online to an account of interest; specification means for specifying a traffic site near an activity site of a friend user who uses the friend account based on the acquired friend account information; calculation means for calculating an estimated movement route of a user of interest who uses the account of interest, the estimated movement route including the specified traffic site; and display means for displaying the calculated estimated movement route.

A route display method according to the present disclosure includes: acquiring friend account information of a friend account that is connected online to an account of interest; specifying a traffic site near an activity site of a friend user who uses the friend account based on the acquired friend account information; calculating an estimated movement route of a user of interest who uses the account of interest, the estimated movement route including the specified traffic site; and displaying the calculated estimated movement route.

A non-transitory computer readable medium storing a program according to the present disclosure is a non-transitory computer readable medium storing a program for causing a computer to: acquire friend account information of a friend account that is connected online to an account of interest; specify a traffic site near an activity site of a friend user who uses the friend account based on the acquired friend account information; calculate an estimated movement route of a user of interest who uses the account of interest, the estimated movement route including the specified traffic site; and display the calculated estimated movement route.

### Advantageous Effects of Invention

According to the present disclosure, it is possible to provide a route display apparatus, a route display method, and a non-transitory computer readable medium storing a program that are capable of knowing an estimated action area of a user.

### BRIEF DESCRIPTION OF DRAWINGS

FIG. 1 is a flowchart showing a related criminal investigation method;

FIG. 2 is a block diagram showing an outline of a route display apparatus according to example embodiments;

FIG. 3 is a block diagram showing a configuration example of a route display system according to a first example embodiment;

FIG. 4 is a block diagram showing another configuration example of the route display system according to the first example embodiment;

FIG. 5 is a flowchart showing a route display method according to the first example embodiment;

FIG. 6 is a diagram for explaining the route display method according to the first example embodiment;

FIG. 7 is a diagram for explaining the route display method according to the first example embodiment;

FIG. 8 is a diagram for explaining the route display method according to the first example embodiment;

FIG. 9 is a diagram for explaining the route display method according to the first example embodiment;

FIG. 10 is a diagram showing an image of a display example according to the first example embodiment;

FIG. 11 is a diagram showing an image of a display example according to the first example embodiment;

FIG. 12 is a block diagram showing a configuration of a route display system according to a second example embodiment;

FIG. 13 is a flowchart showing a route display method according to the second example embodiment;

FIG. 14 is a diagram showing an image of a display example according to the second example embodiment;

FIG. 15 is a flowchart showing a route display method according to a third example embodiment;

FIG. 16 is a diagram showing an image of a display example according to the third example embodiment;

FIG. 17 is a flowchart showing a route display method according to another example embodiment;

FIG. 18 is a diagram showing an image of a display example according to the other example embodiment;

FIG. 19 is a diagram showing an image of a display example according to the other example embodiment;

FIG. 20 is a diagram showing an image of a display example according to the other example embodiment;

FIG. 21 is a diagram showing an image of a display example according to the other example embodiment; and

FIG. 22 is a block diagram showing an outline of hardware of a computer according to the example embodiments.

### DESCRIPTION OF EMBODIMENTS

Example embodiments will be described hereinafter with reference to the drawings. The same elements are denoted by the same reference symbols throughout the drawings, and redundant descriptions will be omitted as necessary.

### Study Conducted Before the Example Embodiments were Conceived of

As an example of cooperation between cyberspace and the real world, a criminal investigation using cyberspace is studied. In recent years, with the spread of the Internet, crimes using cyberspace have increased, and threats in cyberspace have been considered problematic. Cyberspace is used mainly for the purpose of planning crimes and raising funds for crimes, and it is important to specify persons involved in crimes in the cyberspace in order to prevent such crimes from occurring.

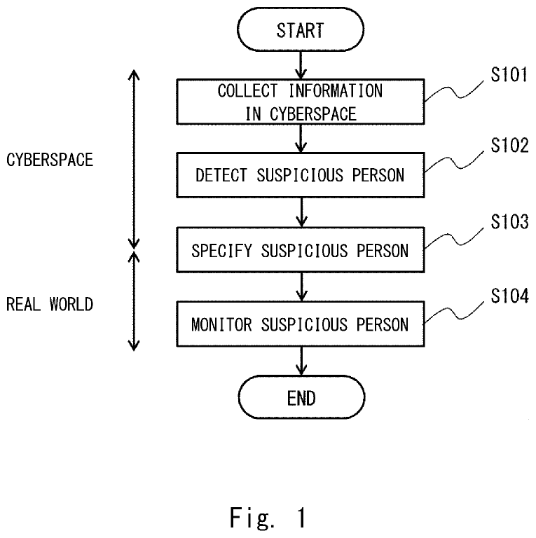

FIG. 1 shows a related criminal investigation method. As shown in FIG. 1, in an investigation of a crime using cyberspace, information possibly related to a crime is collected in the cyberspace (S101), and a suspicious person is detected based on the collected information pieces (S102). Next, the suspicious person is specified from the information in the cyberspace (S103), and finally the person is monitored in the real world (S104). As described above, an investigation of a crime using cyberspace requires an analysis of information about the cyberspace and specification of the real-world elements (real objects) corresponding to the information.

In order to specify suspicious persons based on information about the cyberspace and monitor them in the real world, the inventors have studied a method for estimating potential places of appearance of persons involved in crimes using the cyberspace and specifying a section to be monitored. As a result, the inventors have found that the related technologies have a problem that it is difficult to specify where in the real world persons involved in crimes maliciously using the cyberspace appear and thus it is difficult to monitor and find suspicious persons. One of the reasons why it is difficult to prevent crimes using cyberspace is the difficulty of specifying persons in the cyberspace. In particular, in the case of terrorism, organized crimes, or the like, the same person often uses a plurality of different SNSs, etc., and further, profile information may be intentionally changed. This fact makes it extremely difficult to specify persons involved in such crimes.

In Non Patent Literature 1, even if the network of an account of interest in the cyberspace can be visualized, it is difficult to know the connection between a user of the account of interest and a user of a related account in the real world (e.g. they live in the same neighborhood). Although the relevance of accounts in cyberspace can be known by the related technologies, it is not suitable for supporting an investigation since there is little information contributing to monitoring of the real world.

Further, in Non Patent Literature 2, even if a certain amount of information about the place of residence of the user of the account of interest can be obtained from cyberspace, a site where the user of the account of interest may appear has not been taken into account. That is, it is not possible to narrow down the section to be monitored in order to monitor the behavior of the user of the account of interest. In the related technologies, even if it is possible to specify a broad range of potential activity sites for the user of the account of interest, it is not possible to narrow down the sites to specific roads, stations, airports, or the like to be monitored.

As described above, in the related technologies, it is not possible to specify the estimated action area of a user (a suspicious person etc.) of the account of interest in order to perform monitoring or the like in a criminal investigation. Therefore, in the following example embodiments, it is made possible to know the estimated action area of a user of the account of interest by focusing on a traffic site such as a station or a road where the user of the account of interest is likely to appear.

### Outline of Example Embodiment

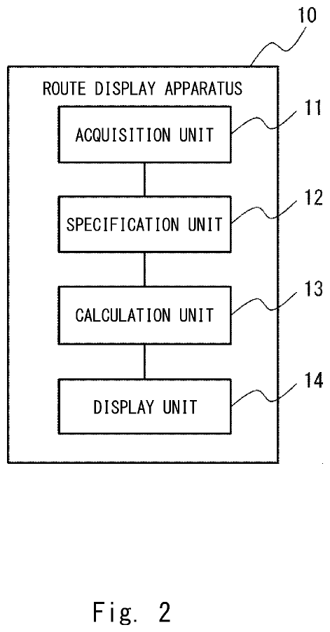

FIG. 2 shows an outline of a route display apparatus according to example embodiments. As shown in FIG. 2, a route display apparatus 10 includes an acquisition unit 11, a specification unit 12, a calculation unit 13, and a display unit 14.

The acquisition unit 11 acquires friend account information of a friend account having a connection with an account of interest online. The specification unit 12 specifies a traffic site near an activity site of a user (a friend user) who uses the friend account based on the friend account information acquired by the acquisition unit 11. The calculation unit 13 calculates an estimated movement route of a user (a user of interest) who uses the account of interest, the estimated movement route including the traffic site specified by the specification unit 12. The display unit 14 displays the estimated movement route calculated by the calculation unit 13.

As described above, according to the example embodiments, it is possible to know an estimated action area where a user of an account of interest is likely to appear by specifying a traffic site such as a station or an intersection near an activity site of a user of a friend account having a connection, such as a friend relationship, with the account of interest, and displaying a route including the traffic site as an estimated movement route of the user of the account of interest.

### First Example Embodiment

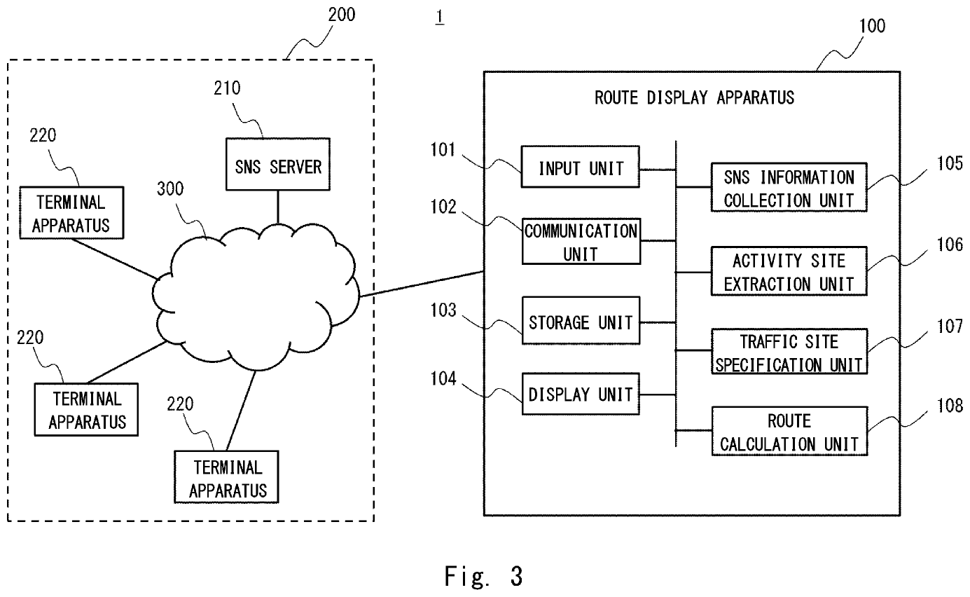

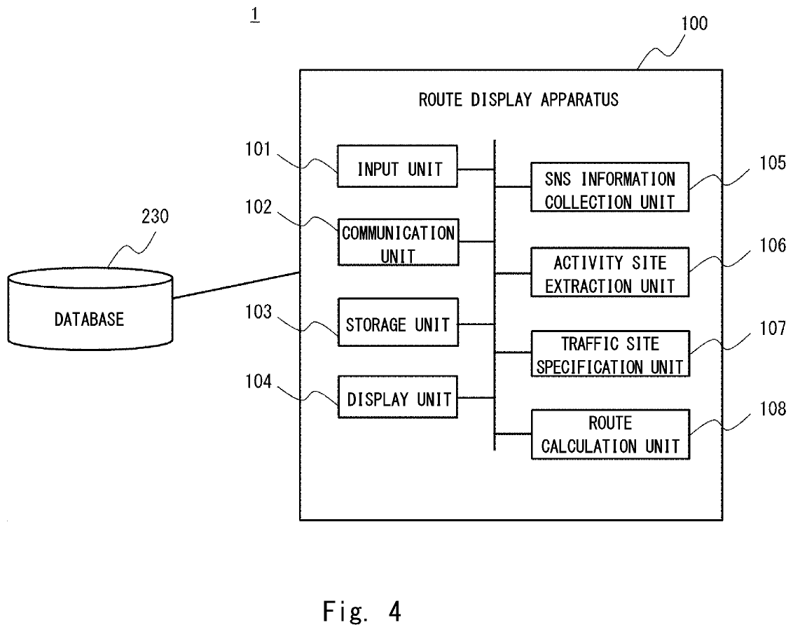

A first example embodiment will be described hereinafter with reference to the drawings. FIG. 3 shows a configuration example of a route display system according to this example embodiment, and FIG. 4 shows another configuration example of the route display system according to this example embodiment. A route display system 1 is a monitoring support system that supports monitoring of a suspicious person by using cyberspace on the Internet in a criminal investigation as shown in FIG. 1. For example, in the example shown in FIG. 3, the route display system 1 includes a route display apparatus 100 and an SNS system 200. In the example shown in FIG. 4, the route display system 1 includes the route display apparatus 100 and a database 230.

In the example shown in FIG. 3, the SNS system 200 includes an SNS server 210 and a plurality of terminal apparatuses 220 operated by a user. The SNS system 200 is a system that provides an SNS service from the SNS server 210 to a user of the terminal apparatus 220 via an Internet 300. Note that the SNS service is an example of an online service that allows a plurality of accounts (users) to have some kind of connection on the Internet (online), and may be, for example, a messaging service such as chat, a blog, an electronic bulletin board, a video sharing site, an information sharing site, and a social media such as a social game or a social bookmark, in addition to a social networking service. In order to provide these services, a plurality of systems (servers) are provided as required.

The SNS server 210 is a management apparatus that provides SNS services, manages accounts, and the like, and is constructed, for example, on the cloud. The terminal apparatus 220 is an SNS client apparatus that accesses the SNS server 210 in response to an operation performed by a user, and may be, for example, a personal computer, a tablet terminal, a smartphone, or a cellular phone. An SNS application (program) installed in the terminal apparatus 220 uses an SNS service via an Application Programming Interface (API) provided by the SNS server 210. For example, a user operates an SNS application to log in with his/her own account, inputs and browses posts on a timeline and chat conversations, and registers account connections such as friend relationships and follow relationships.

In the example shown in FIG. 4, the database 230 is an SNS information storage device that stores in advance account information and SNS information required by the route display apparatus 100. For example, the database 230 may be provided in the route display apparatus 100, or may be an external storage device, and may be connected to the route display apparatus 100 via the Internet 300.

The route display apparatus 100 is connected to the Internet 300 so that it can communicate with the Internet 300, and supports monitoring of a suspicious person (user) who uses a suspicious account by specifying a monitoring section of the suspicious person (user) based on SNS information collected via the Internet 300 or SNS information acquired from the database 230. As shown in FIG. 3, the route display apparatus 100 includes an input unit 101, a communication unit 102, a storage unit 103, a display unit 104, an SNS information collection unit 105, an activity site extraction unit 106, a traffic site specification unit 107, and a route calculation unit 108. Note that each unit (block) configuring the route display apparatus 100 is merely an example, and the route display apparatus 100 may be configured by any other units if a method (an operation) described later can be performed. Further, although the route display apparatus 100 is implemented, for example, by a computer such as a server or a personal computer that executes a map application program, it may instead be implemented by one apparatus or a plurality of apparatuses on the cloud. As an example, the route display apparatus 100 includes the input unit 101, the communication unit (cloud communication unit) 102, and the display unit 104, and other processing may be performed by a computer on the cloud.

The input unit 101 is an input interface that acquires information input from a person (monitor) who performs monitoring and operating of the route display apparatus 100. The input unit 101 receives information corresponding to the operation performed by the person who performs monitoring from input devices such as a keyboard, a mouse, and a touch panel. The input unit 101 may acquire necessary information via a network such as the Internet 300. The input unit 101 acquires information such as the ID of a suspicious account (account of interest) to be monitored (to be a monitoring target).

The communication unit 102 is a communication interface that is connected to a network such as the Internet 300 and that transmits and receives various types of information. The communication system of the communication unit 102 is not limited if necessary information can be transmitted and received, and may be connected to a network wirelessly or by wire. The communication unit 102 accesses the SNS server 210 via the Internet 300 in order to collect SNS information and the like of the suspicious account.

The storage unit 103 is a storage unit (storing unit) that stores information (data) necessary for the operation (processing) of the route display apparatus 100, and is, for example, a nonvolatile memory such as a flash memory or a hard disk device. The storage unit 103 stores map information and the like used for calculation and display of an estimated movement route of a suspicious person. Note that the storage unit 103 may be a storage device external to the route display apparatus 100, and may be connected to the route display apparatus 100 via the Internet 300. That is, the route display apparatus 100 may acquire map information and the like from the Internet 300 or the like as required.

The SNS information collection unit 105 collects necessary SNS information from the Internet 300 or from the database 230. The SNS information collection unit 105 acquires information (suspicious account information) about a suspicious account itself and information (friend account information) about a friend account having a connection, such as a friend relationship, with the suspicious account from the SNS server 210 as SNS information pieces related to the suspicious account. For example, the SNS information collection unit 105 is an acquisition unit that acquires the friend account information of the friend account.

The activity site extraction unit 106 extracts an activity site of a user based on the collected SNS information pieces. The activity site extraction unit 106 extracts an activity site such as a place of residence of a user (suspicious person) who uses a suspicious account based on information about the suspicious account, and extracts information about an activity site of a user (friend) who uses a friend account based on information about the friend account.

The traffic site specification unit 107 specifies a traffic site of the user based on the extracted activity site of the user. The traffic site specification unit 107 specifies a traffic site such as a station or an intersection nearest to (near) the activity site of the user (suspicious person) of the suspicious account, and specifies a traffic site near the activity site of the user (friend) of the friend account. For example, the activity site extraction unit 106 and the traffic site specification unit 107 are specification units that specify a traffic site near an activity site of a user of the friend account based on the friend account information.

The route calculation unit 108 calculates an estimated movement route of the suspicious person based on the specified traffic site of the user. The route calculation unit 108 calculates, as the estimated movement route of the suspicious person, a route including a traffic site nearest to the activity site of the friend, in particular, a route including a traffic site nearest to the activity site of the friend as an end point (a starting point or an ending point). In this example embodiment, a route connecting the traffic site nearest to the activity site of the suspicious person to the traffic site nearest to the activity site of the friend is calculated. Further, the route calculation unit 108 may also calculate routes among traffic sites of a plurality of friends. That is, when, for example, the activity site of the suspicious person is unknown, a route connecting a first traffic site near an activity site of a first friend user who uses a first friend account to a second traffic site near an activity site of a second friend user who uses a second friend account may be calculated.

The display unit 104 is a display unit that displays a result and the like of the operation (processing) of the route display apparatus 100, and is, for example, a display apparatus such as a liquid crystal display and an organic EL display. The display unit 104 highlights the calculated estimated movement route of the suspicious person by a Graphical User Interface (GUI). Note that the display unit 104 may be a display apparatus external to the route display apparatus 100, and may display the estimated movement route on a smartphone or the like via the Internet 300.

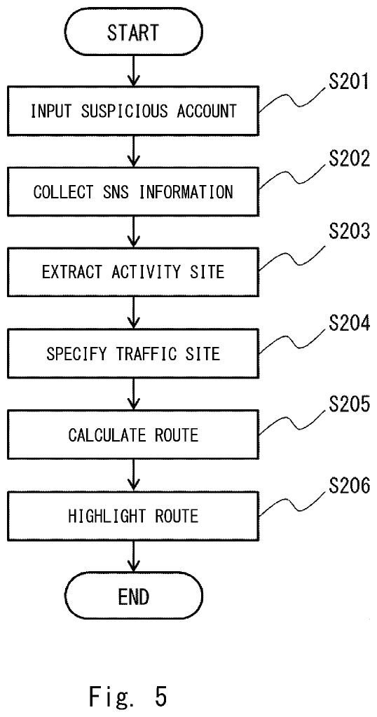

FIG. 5 shows a route display method (a route display method) performed by the route display apparatus according to this example embodiment. As shown in FIG. 5, first, a person who performs monitoring inputs a suspicious account to the route display apparatus 100 (S201). For example, the person who performs monitoring prepares a list of suspicious persons having a high possibility of being involved in a crime based on information on the Internet 300, and inputs information about the suspicious account included in the list of suspicious persons. The person who performs monitoring operates a keyboard or the like to input ID (identification information) of the suspicious account, and the input unit 101 acquires this information. The input information is information necessary for collecting SNS information of the suspicious account, and includes the ID of the account, the type of SNS, and the like.

Next, the route display apparatus 100 collects SNS information of the suspicious account and the friend account (S202). The SNS information collection unit 105 specifies the SNS server 210 providing an SNS service from the input information about the suspicious account, and collects SNS information pieces related to the suspicious account by using an API of the SNS server 210. Alternatively, required SNS information related to the suspicious account is acquired from the database 230 storing a large amount of SNS information in advance. The SNS information (account information) of the account to be collected includes the profile of the account, registered friend relationships and follow relationships, the posts and conversations of the account, and the like.

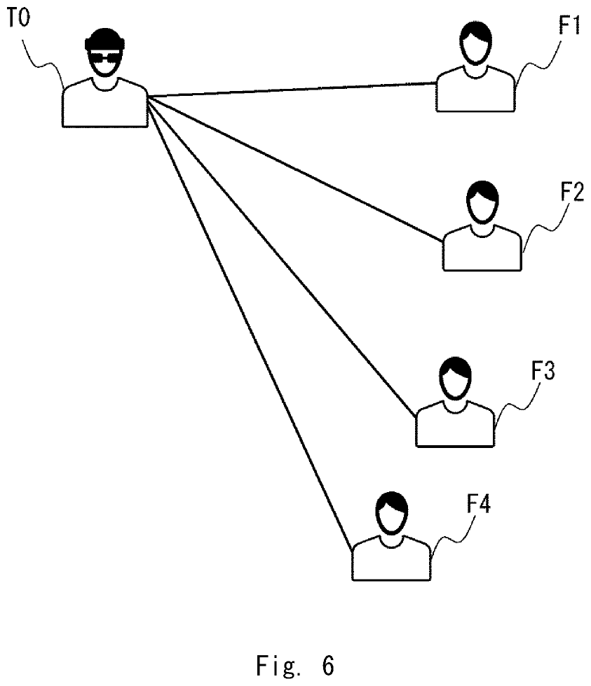

For example, as shown in FIG. 6, an account registered as a friend of a suspicious account T0 is searched for, and relevant F1 to F4 are specified as friend accounts. The friend account is an account that has a connection with a suspicious account of interest on the Internet (online). That is, the friend account is specified not only by the registration of the friend relationship but also by the registration of the follow relationship, the connection through the posts (comments on the posts, etc.), the connection through the conversation (conversation in the same community), and the like. Further, the friend account may be specified from other registered SNS information, such as the profile (the workplace, school, place of residence, hometown, age, gender, hobbies, and the like) of the suspicious account. For example, conditions and ranges for extracting friend accounts may be selectable. Note that a list of friend accounts may be input as information about the suspicious account. The SNS information collection unit 105 further collects the SNS information of the specified friend accounts (e.g., F1 to F4) in a manner similar to that by which the SNS information of the suspicious accounts is collected.

Next, the route display apparatus 100 extracts the activity site of the user of each of the suspicious account and the friend account based on the collected SNS information pieces (S203). The activity site extraction unit 106 extracts the activity site of the user of the suspicious account from the collected profiles of the suspicious account, position information of the posts and the conversation, and the like. The activity site of the user to be extracted includes the place of residence of the user, the workplace or school the user attends, the stores where the user often shops, and the restaurants where the user often eats. That is, not only one activity site but instead a plurality of activity sites may be extracted. Further, in some cases, such as a case in which the suspicious account has been set so that it cannot be viewed by a third party, it is not possible to extract the activity site of the user from the information about the suspicious account, and therefore the activity site of the user of the suspicious account may be extracted by using not only the information about the suspicious account itself but also the SNS information of the (tagged) friend account associated with the suspicious account. Note that the activity site of the suspicious account may be input as the information about the suspicious account. The activity site extraction unit 106 extracts the activity site of the user of each friend account from the collected SNS information pieces of the friend accounts (e.g., F1 to F4) in a manner similar to that by which the activity site of the user of the suspicious account is extracted.

Next, the route display apparatus 100 specifies a traffic site of the user of each of the suspicious account and the friend account based on the extracted activity site (S204). The traffic site specification unit 107 refers to map information of the storage unit 103 and specifies the traffic site used by the user of the suspicious account. The traffic site of the user to be specified includes a station, an intersection, a bus stop, an airport, and the like. In this example, it is assumed that a station or the like nearest to the activity site of the user is the traffic site. Although it is preferable for the station or the like nearest to the activity site to be used, the second or third nearest station or the like may be used if the user can use it from the activity site (e.g., a station used by many users). For example, a means of transportation (method of transportation, or mode of transportation) used by the user of the suspicious account is made selectable by the GUI, and the traffic site nearest to the activity site is specified in accordance with the means of transportation selected by the person who performs monitoring. Note that the means of transportation may be automatically selected from information such as the profiles, or the nearest traffic site may be automatically specified without selecting the means of transportation. For example, when the means of transportation is a train, the nearest station is specified, when the means of transportation is a vehicle, walking, or a bicycle, the nearest intersection is specified (in the case of a vehicle, a highway service area may be specified), when the means of transportation is a bus, the nearest bus stop is specified, and when the means of transportation is an airplane, the nearest airport is specified. A plurality of means of transportation, such as trains and airplanes, may be selected.

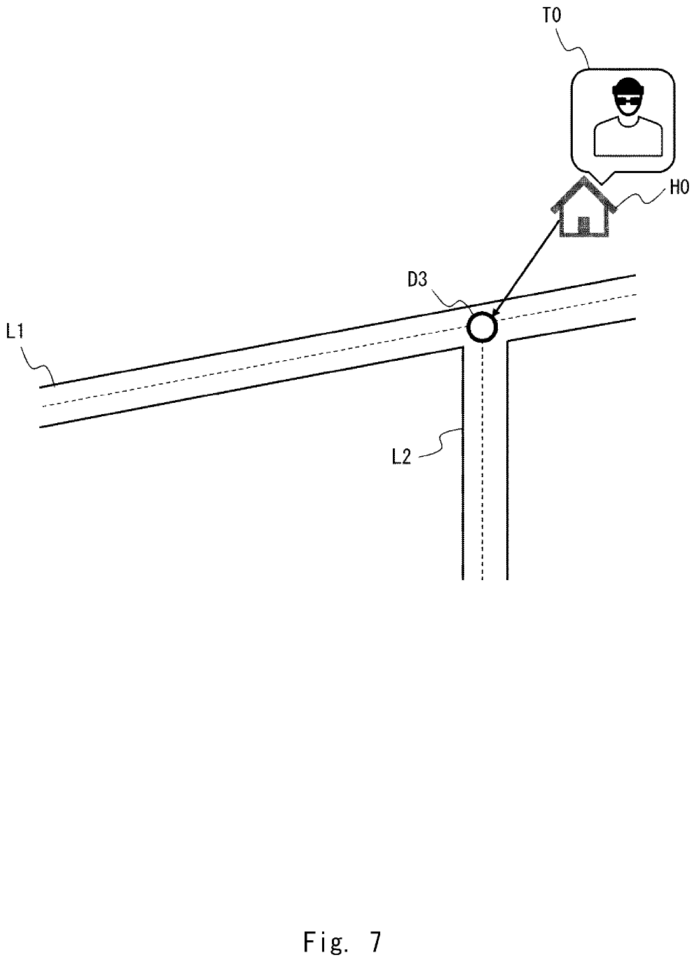

For example, as shown in FIG. 7, when an activity site (a place of residence) H0 of the suspicious account T0 is extracted and a train is selected as a means of transportation, stations near the activity site H0 are searched for, and a station D3 of a line L1 and a line L2 nearest to the activity site H0 is specified as the traffic site of the user (suspicious person) of the suspicious account. The activity site is, for example, a place of residence, place of work, and school of the user, which it is estimated that the user visits frequently. Note that when a plurality of activity sites are extracted, the nearest traffic site may be specified for each activity site, or the traffic site nearest to the plurality of activity sites may be specified.

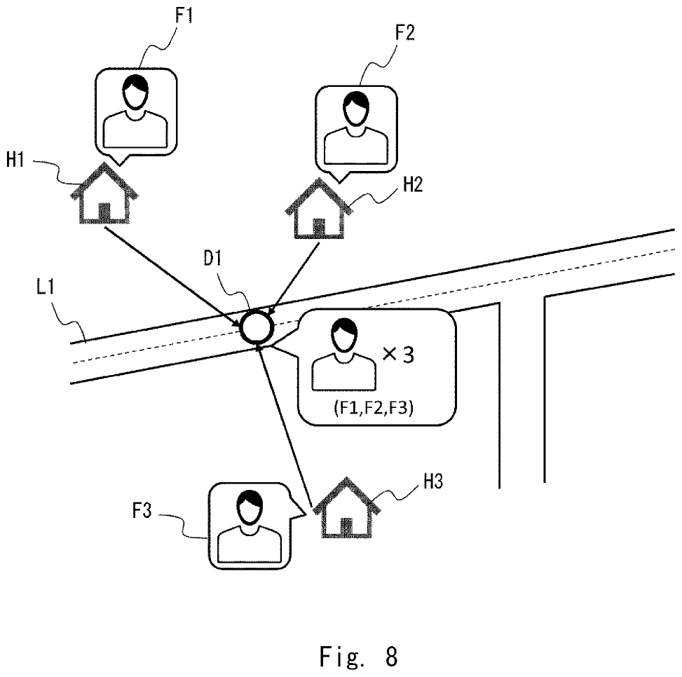

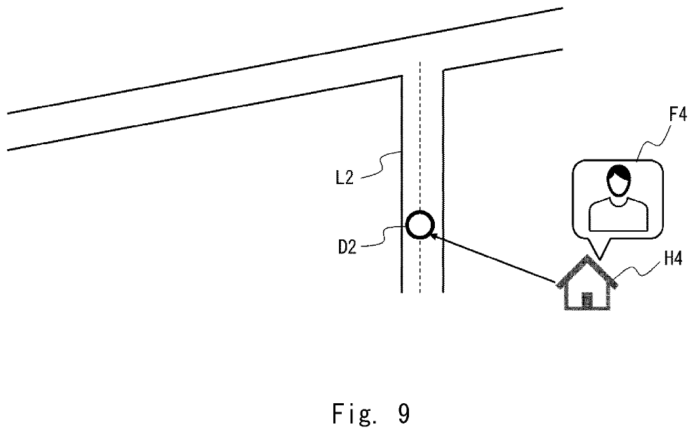

Similarly, the traffic site specification unit 107 specifies a traffic site used by the user of the friend account. For example, as shown in FIG. 8, when activity sites H1 to H3 of the respective friend accounts F1 to F3 are extracted and a train is selected as a means of transportation, a station D1 of the line L1 nearest to the activity sites H1 to H3 is specified as a traffic site of the users (friends) of the friend accounts F1 to F3. Further, as shown in FIG. 9, when the activity site H4 of the friend account F4 is extracted and a train is selected as a means of transportation, a station D2 of the line L2 nearest to the activity site H4 is specified as a traffic site of the user (friend) of the friend account F4.

Next, the route display apparatus 100 calculates an estimated movement route of the suspicious person based on the specified traffic site (S205). The route calculation unit 108 refers to the map information of the storage unit 103 and calculates routes starting from the traffic site of the user of the suspicious account and ending at the traffic site of the user of each friend account. For example, the conditions (the fastest route, the cheapest route, the shortest route, etc.) for calculating the route may be made selectable by the GUI, and the route may be calculated in accordance with the conditions selected by the person who performs monitoring. Note that when a plurality of traffic sites of the user of the suspicious account are specified, a plurality of routes including the respective traffic sites are selected.

Next, the route display apparatus 100 highlights the calculated estimated movement route of the suspicious person (S206). The display unit 104 displays a map around the estimated movement route of the suspicious person based on the map information of the storage unit 103, and highlights the estimated movement route of the suspicious person on the map. Any highlighting method in which the estimated movement route can be recognized may be employed.

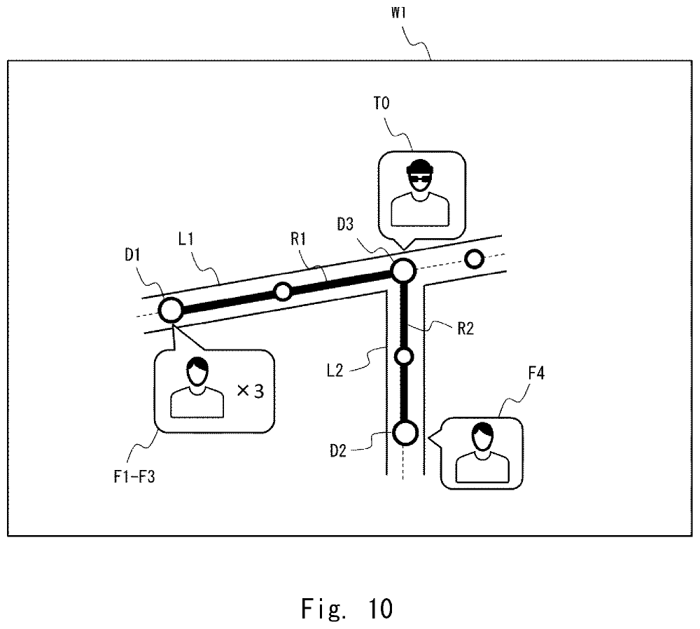

FIG. 10 shows a display example when the estimated movement route is calculated using the stations D1 to D3 shown in FIGS. 7 to 9 as traffic sites. For example, as shown in FIG. 10, the line L1 and the stations on the line L1 (D1, D3, etc.) and the line L2 and the stations on the line L2 (D2 etc.) are displayed on a display window W1. Further, icons of the suspicious account and the friend accounts and the number of friend accounts are shown in a balloon frame so that it can be recognized that the station D3 is a traffic site of the suspicious account T0, the station D1 is a traffic site of the friend accounts F1 to F3, and the station D2 is a traffic site of the friend account F4. Instead of the icons of the suspicious account and the friend accounts, an image of the face of each account may be displayed. Further, a route R1 from the station D3 of the suspicious account T0 to the station D1 of the friend accounts F1 to F3 is highlighted by a bold line, and a route R2 from the station D3 of the suspicious account T0 to the station D2 of the friend account F4 is highlighted by a bold line. Note that the activity sites H0 to H4 of the respective accounts may be displayed.

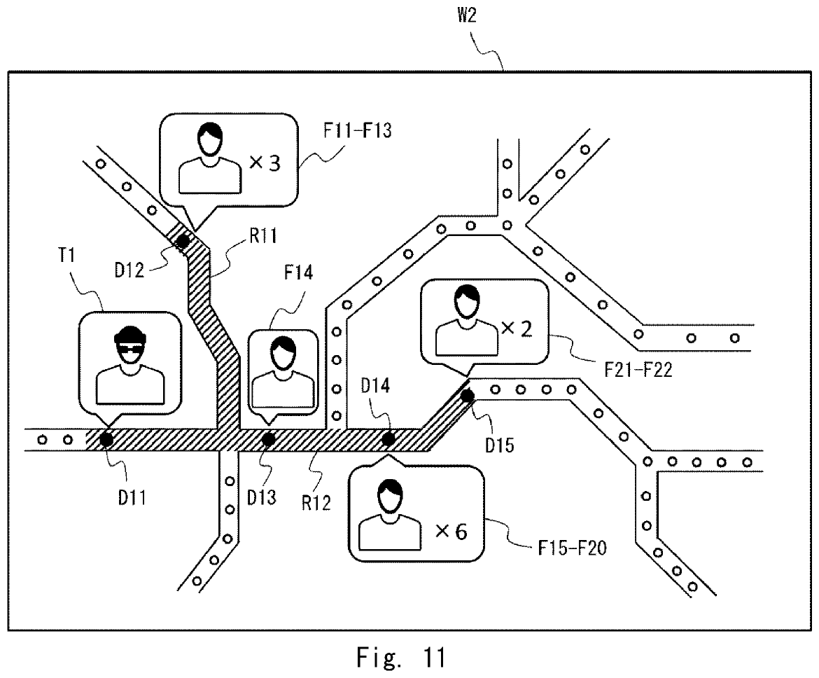

FIG. 11 shows another display example. In the example shown in FIG. 11, a route R11 from a traffic site D11 of a suspicious account T1 to a traffic site D12 of friend accounts F11 to F13, and a route R12 from a traffic site D11 of the suspicious account T1 to a traffic site D13 of a friend account F14, a traffic site D14 of friend accounts F15 to F20, and a traffic site D15 of friend accounts F21 to F22 are highlighted in a diagonal line pattern in a display window W2.

As described above, in this example embodiment, a traffic site such as a station or a road where a user (suspicious person) who uses the suspicious account is likely to appear is specified and a route including the traffic site is highlighted on a map as a monitoring section by using information about a friend account having a connection, such as a friend relationship, with the suspicious account. By the above, it is possible to enhance the visibility of a monitoring area, improve the efficiency of operations of investigation and monitoring, and prevent crimes effectively.

In particular, since the suspicious person is likely to meet the user of the friend account on a regular basis, the monitoring area can be narrowed down to a specific section by estimating a route including a traffic site that can be used by the suspicious person when he/she meets the user of the friend account as a movement route.

### Second Example Embodiment

Next, a second example embodiment will be described. In this example embodiment, in the route display method according to the first example embodiment, monitoring information such as a video image of a monitoring camera is further displayed.

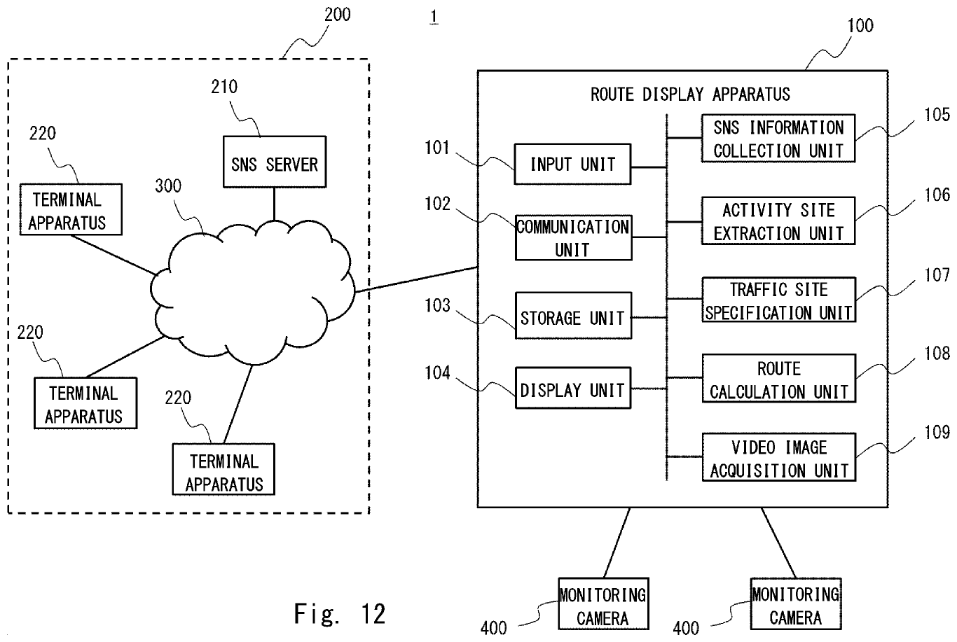

FIG. 12 shows a configuration of a route display system according to this example embodiment. As shown in FIG. 12, in addition to the configuration described in the first example embodiment shown in FIG. 3, the route display system 1 includes a plurality of monitoring cameras 400 (the same is applied to the configuration shown in FIG. 4). The monitoring camera 400 is installed in a traffic site such as a station or an intersection, and is connected to the route display apparatus 100 so that it can communicate with the route display apparatus 100. The monitoring camera 400 may be connected to the route display apparatus 100 via the Internet 300 or via another monitoring network. Further, the route display apparatus 100 includes a video image acquisition unit 109 that acquires a video image of the monitoring camera 400. The video image acquisition unit 109 acquires a monitoring video image from the monitoring camera 400 installed on an estimated movement route of the suspicious person. Further, the SNS information collection unit 105 acquires SNS information related to the estimated movement route of the suspicious person. For example, the SNS information collection unit 105 collects, as information in the estimated movement route, posts and the like from all the accounts including the suspicious account and the friend accounts based on position information of the posts.

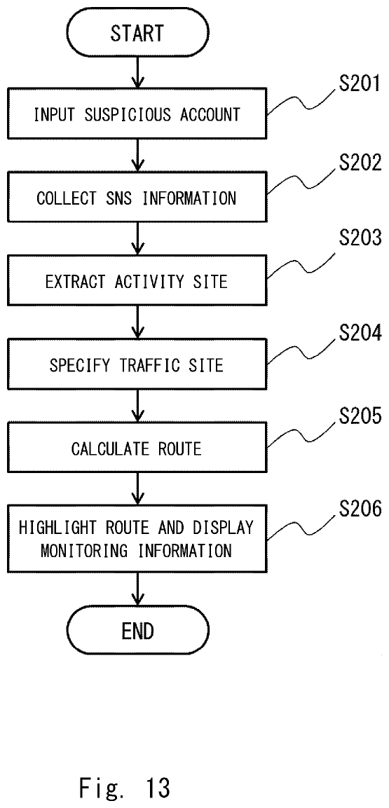

FIG. 13 shows a route display method according to this example embodiment. First, like in the first example embodiment, a traffic site of a user of each of a suspicious account and a friend account is specified based on information about each of these accounts, and an estimated movement route of a suspicious person is calculated based on each of the traffic sites (S201 to S205).

Next, in this example embodiment, the route display apparatus 100 displays the estimated movement route of the suspicious person and also displays monitoring information (S206). The display unit 104 displays the estimated movement route of the suspicious person on a map, and further displays, as the monitoring information, a video image (an image) in the estimated movement route acquired by the video image acquisition unit 109 from the monitoring camera 400 and SNS information posted or the like in the estimated movement route acquired by the SNS information collection unit 105. For example, the face of the suspicious person may be recognized from the video image or the posted image in the estimated movement route and displayed based on the image of the face of the suspicious person.

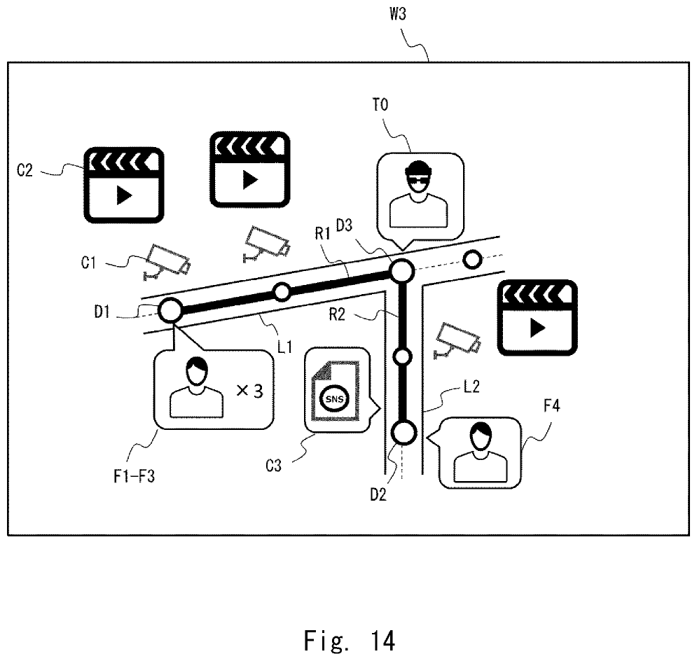

For example, as shown in FIG. 14, like in the case of FIG. 10, the route R1 from the station D3 of the suspicious account T0 to the station D1 of the friend accounts F1 to F3, and the route R2 from the station D3 of the suspicious account T0 to the station D2 of the friend account F4 are highlighted on a display window W3. Further, an icon of a monitoring camera C1 installed at the station of each route R1 and R2 and an icon of a video image display unit (display part) C2 that displays a video image of the monitoring camera C1 are displayed. When the icon of the video image display unit C2 is clicked, the video image of the station captured by the corresponding monitoring camera is displayed. Further, an icon of an SNS display unit (display part) C3 that displays SNS information of the routes R1 and R2 is displayed. When the icon of the SNS display unit C3 is clicked, SNS information (posted image etc.) of the corresponding position is displayed.

As described above, in this example embodiment, a section to be monitored (an estimated movement route) is highlighted, and a monitoring camera video image in the section to be monitored and information (an image, a text, etc.) posted in the section are displayed on the map so that they can be checked. By the above, it is possible to facilitate collection of information in the section to be monitored and to improve the efficiency of operations of investigation and monitoring.

### Third Example Embodiment

Next, a third example embodiment will be described. In this example embodiment, in the route display method according to the second example embodiment, a route is further highlighted based on weighting of the route. Note that, in the route display method according to the first example embodiment, a weighted display according to this example embodiment may be performed.

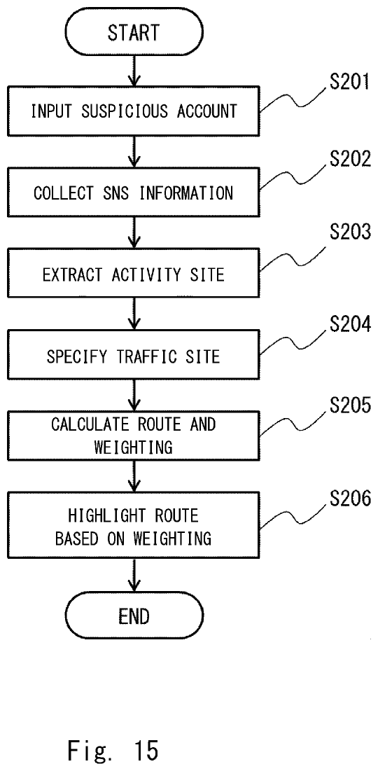

FIG. 15 shows a route display method according to this example embodiment. First, like in the second example embodiment, a traffic site of a user of each of a suspicious account and a friend account is specified based on information about each of these account (S201 to S204). Next, in this example embodiment, the route display apparatus 100 calculates an estimated movement route and weighting of this route (S205). The route calculation unit 108 calculates a route from the traffic site of the user of the suspicious account to the traffic site of the user of each friend account, and weights (prioritizes) each route. The weighting of a route is calculated based on information such as account information, information about posts and the like, the number of friends, closeness with friends (whether or not they meet frequently, whether or not they work together, etc.), and a crime map (whether or not the crime rate is high etc.).

Next, the route display apparatus 100 highlights the estimated movement route based on the calculated weighting (S206). The display unit 104 highlights each of the estimated movement routes in accordance with the weighting. Further, like in the second example embodiment, a video image of the monitoring camera 400 on the estimated movement route, SNS information, and the like are displayed.

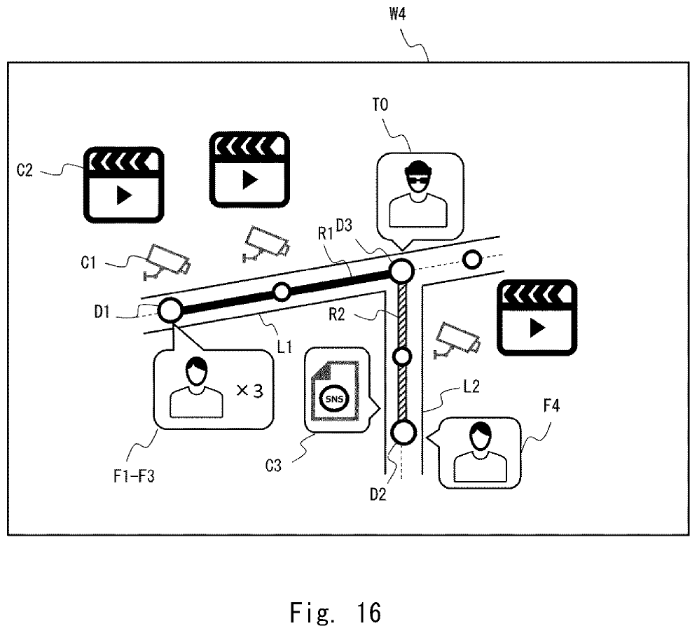

For example, as shown in FIG. 16, like in the case of FIG. 14, the route R1 from the station D3 of the suspicious account T0 to the station D1 of the friend accounts F1 to F3, the route R2 from the station D3 of the suspicious account T0 to the station D2 of the friend account F4, and the video image display unit C2 of the monitoring camera C1 of each station and the SNS display unit C3 displaying SNS information are displayed on a display window W4. In this route display, the highlighting method is changed in accordance with the weighting of the route R1 and the weighting of the route R2 and then a display is performed. For example, the route R1 is displayed by a bold line since it has a large number of friends and its weighting is large (the priority is high), and the route R2 is displayed by a diagonal line since it has a small number of friends and its weighting is small (the priority is low).

As described above, in this example embodiment, in order to specify a section to be monitored (an estimated movement route) in which a user of a suspicious account is likely to appear, a route to be monitored is weighted based on prior information such as information about the account, the number of friends, and a crime map, and a highlighting method (a color, transmittance, color density, etc.) is changed. By the above, it is possible to enhance the visibility and further improve the monitoring efficiency. Further, a friend may be weighted in accordance with the number of times messages are exchanged. By the above, it is possible to calculate the route to be monitored with higher accuracy, and thus it is possible to improve the monitoring efficiency.

### Other Example Embodiments

In the above-described example embodiments, an example has been described in which an estimated movement route of a suspicious person is displayed in order to monitor the suspicious person. However, the estimated movement route of a user may be calculated and displayed for purposes other than monitoring. As an example, the example embodiments can be applied to the marketing and the like of targeting advertisements. When the application of the example embodiments to marketing is considered, like in the case of monitoring in the criminal investigations described above, there is a problem in regard to the relation between account connections in cyberspace and user connections in the real world.

That is, in the related technologies, it is difficult to know the connection between a store operating an SNS account and a user of the related account in the real world (e.g., they live in the same neighborhood). Although the relation between accounts in cyberspace can be known by the related technologies, it is difficult to use the related technologies for analysis of accounts for real-world activities (such as placing ads on public transportation) that can easily lead to improved store sales.

Further, in the related technologies, even if a certain amount of information about the place of residence of a user of an account of interest can be obtained from cyberspace, a route for a user related to a store account of interest to the store is unknown. That is, although it is possible to specify a broad range of possible activity sites for the user related to the store account, it is not possible to narrow down the sites to the specific routes or roads on which advertisements should be posted.

Therefore, as another example embodiment, a movement route used by a user of the related account when he/she visits the store is estimated and the estimated movement route is highlighted on the map, whereby it is possible to visually recognize the movement route used when he/she visits the store. Specifically, assuming that the user (customer) of the related account is highly likely to visit the store on a regular basis, the movement route such as a road or a station to be used when he/she comes to the store is estimated and the estimated movement route is highlighted on the map, to thereby enhance the visibility.

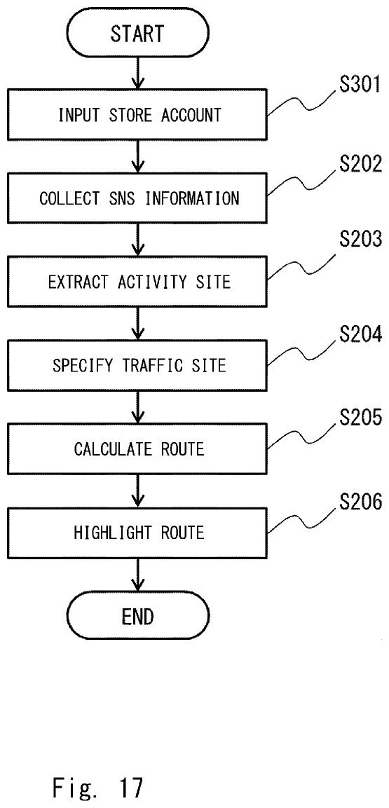

In the other example embodiment, a system configuration and an apparatus configuration similar to those of the first example embodiment shown in FIGS. 3 and 4 can be implemented. FIG. 17 shows a route display method according to the other example embodiment. As compared with the first example embodiment, the method of the other example embodiment is basically similar to that shown in FIG. 5 except that a store account is input instead of a suspicious account (S301).

That is, first, a person in charge of marketing inputs a store account to the route display apparatus 100 (S301). The ID and the like of the account of the store for which marketing is to be performed is input. Next, the route display apparatus 100 collects SNS information of the store account and a customer account (S202). SNS information such as profiles of the customer account (friend account) having a connection, such as a friend relationship and a follow relationship, with the store account is collected.

Next, the route display apparatus 100 extracts an activity site of a user of each of the store account and the customer account based on the collected SNS information pieces (S203), and specifies traffic sites of the users of the store account and the customer account based on the extracted activity sites (S204). Next, the route display apparatus 100 calculates the estimated movement route of the customer based on the specified traffic site (S205), and highlights the calculated estimated movement route of the customer (S206).

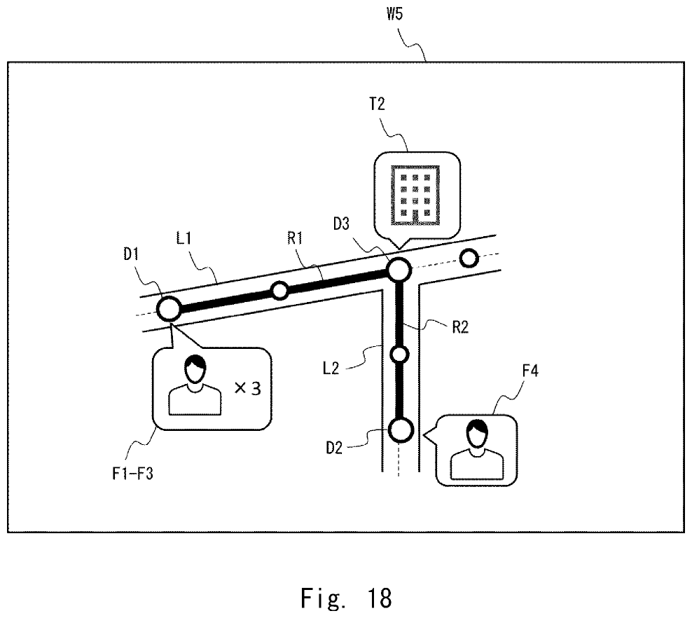

FIG. 18 shows a display example of the estimated movement route of the customer in the other example embodiment. For example, as shown in FIG. 18, like in the case of FIG. 10 of the first example embodiment, the line L1 and the stations on the line L1 (D1, D3, etc.) and the line L2 and the stations on the line L2 (D2 etc.) are displayed on a display window W5. Further, assuming that the station D3 is a traffic site of a store account T2, the station D1 is a traffic site of the customer accounts F1 to F3, and the station D2 is a traffic site of the customer (friend) account F4, icons of the store account and the customer accounts and the number of friend accounts are shown in a balloon frame so that these traffic sites can be recognized. Further, the route R1 from the station D3 of the store account T2 to the station D1 of the customer accounts F1 to F3 is highlighted by a bold line, and the route R2 from the station D3 of the store account T2 to the station D2 of the customer account F4 is highlighted by a bold line.

By the above, it is possible to highlight the estimated movement route of the customer. Therefore, it is possible to enhance the visibility of the target area of the marketing, improve the efficiency of the advertising operation and the like, and discuss an effective marketing strategy.

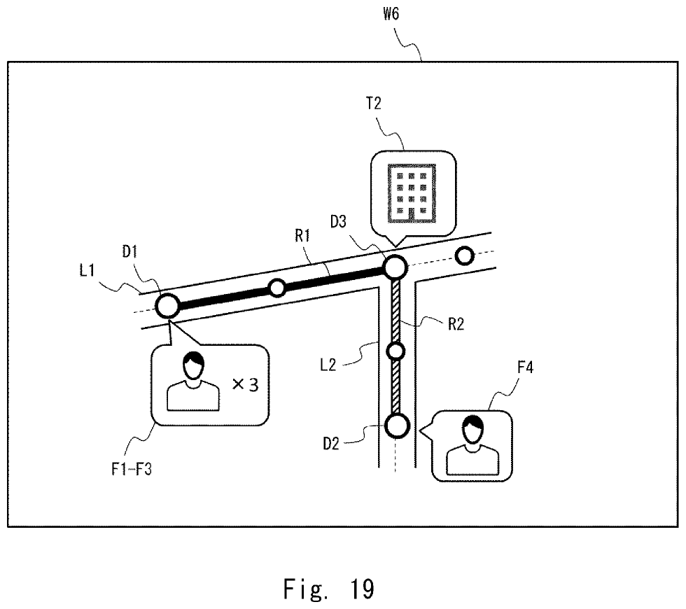

Further, in the other example embodiment, like in the third example embodiment, a route may be highlighted based on weighting of the route. FIG. 19 shows an example in which the estimated movement route of the customer is highlighted based on the weighting in other example embodiment. For example, as shown in FIG. 19, like in the case of FIG. 18, when the route R1 from the station D3 of the store account T2 to the station D1 of the customer accounts F1 to F3 and the route R2 from the station D3 of the store account T2 to the station D2 of the customer account F4 are displayed in a display window W6, a highlighting method is changed in accordance with the weighting of the route R1 and the weighting of the route R2 and then a display is performed. For example, in order to specify a movement route that many customers use when they visit a store, the route display apparatus 100 calculates weighting of the route based on account information, the number of customer accounts, the number of users using each line, etc., and changes a method for highlighting the estimated movement route (a color, transmittance, etc.) based on the calculated weighting. For example, the route R1 is displayed by a bold line since it has a large number of customers and the weighting is large (the priority is high), and the route R2 is displayed by a diagonal line since it has a small number of customers and the weighting is small (the priority is low). By the above, it is possible to further enhance the visibility of the estimated movement route of the customer and further improve the efficiency of the marketing operation.

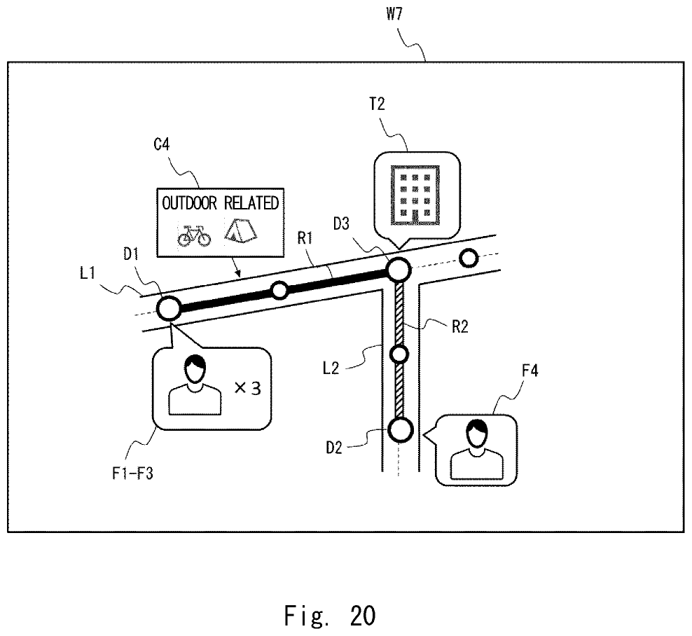

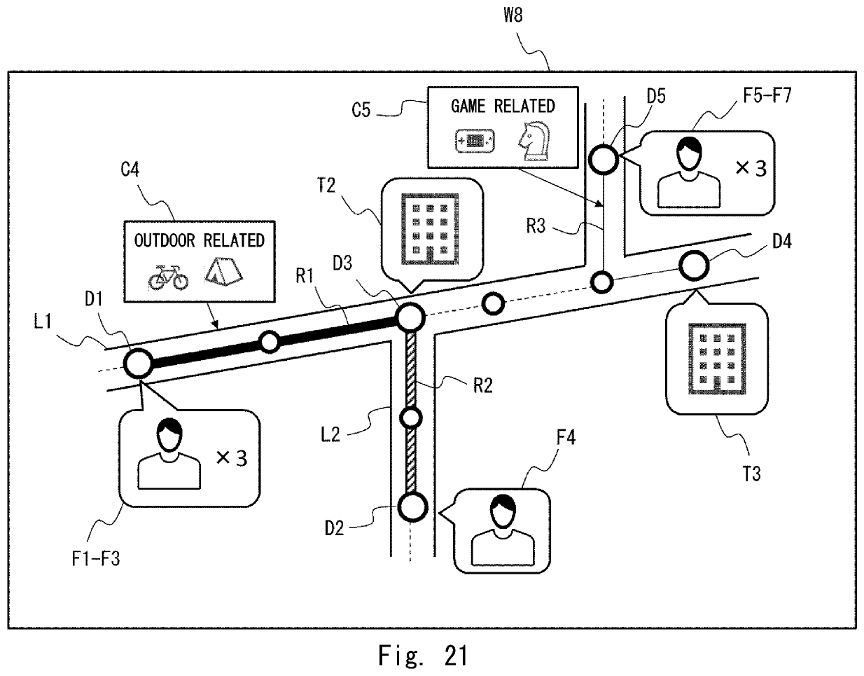

Further, in the other example embodiment, as shown in FIGS. 20 and 21, in addition to the estimated movement route of the customer, related advertisements on the route may be presented. In the example shown in FIG. 20, in the display window W6, in addition to the display of FIG. 19, an icon of an outdoor related advertisement C4 is displayed on the route R1 from the station D3 of the store account T2 to the station D1 of the customer accounts F1 to F3 as an advertisement related to the customer accounts F1 to F3 using this route. For example, the route display apparatus 100 analyzes the attributes (gender and age) and hobbies and tastes of a user who owns the customer account, specifies what type of advertisement should be placed on which route based on a result of the analysis, and displays the specified type of the advertisement on each route. In this example, it is assumed that the customer account F1 is a man in his twenties and his hobby is mountain climbing, the customer account F2 is a man in his thirties and his hobby is cycling, and the customer account F3 is a man in his twenties and his hobby is playing games, and based on these results of analysis, outdoor related advertisements are presented. Further, assuming that the customer account F4 is as a woman in her thirties and her hobby is reading, advertisements for books may be presented. By the above, it is possible to enhance the visibility of the estimated movement route of a customer and present the advertisement corresponding to the customer, and therefore it is possible to further improve the efficiency of the marketing operation.

In the example shown in FIG. 21, in the display window W6, in addition to the display of FIG. 20, stores of competitors, customers of competitors, and related advertisements are displayed. For example, assuming that a station D4 is a traffic site of a store account T3 of the competitor and the station D5 is a traffic site of customer accounts F5 to F7 of the competitor, a route R3 from a station D4 to a station D5 is displayed. Further, an icon of a game related advertisement C5 is displayed on the route R3 as an advertisement related to the customer accounts F5 to F7 of the competitor using this route. For example, a specified competitor and its customer account are displayed, and an advertisement matching the attributes and hobbies and tastes of the customer of the competitor is further presented. In this example, it is assumed that the customer account F5 is a man in his twenties and his hobby is playing games, the customer account F6 is a woman in her thirties and her hobby is playing games, and the customer account F7 is a woman in her twenties and her hobby is cycling, and based on these results of analysis, game related advertisements are presented. By the above, it is possible to know the estimated movement routes of the customers of the competitor and also know advertisements corresponding to the customers of the competitor, and therefore it is possible to discuss a more effective marketing strategy.

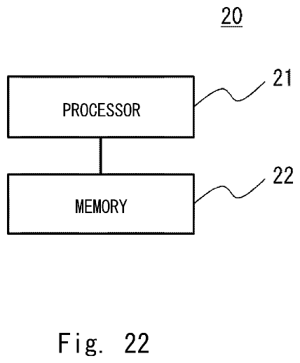

Note that each component in the above-described example embodiments may be configured by software, hardware, or both of them, and may be configured by one piece of hardware or software, or a plurality of pieces of hardware or software. The function (processing) of each of the route display apparatus 10 and the route display apparatus 100 may be implemented by a computer 20 including a processor 21 such as a Central Processing Unit (CPU) and a memory 22 as a storage device as shown in FIG. 22. For example, a program (a route display program) for performing the method according to the example embodiments may be stored in the memory 22, and each function may be implemented by having the processor 21 execute the program stored in the memory 22.

The above programs can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The programs may be provided to a computer using any type of transitory computer readable media. Examples of transitory computer readable media include electric signals, optical signals, and electromagnetic waves. Transitory computer readable media can provide the programs to a computer via a wired communication line (e.g., electric wires, and optical fibers) or a wireless communication line.

Further, the present disclosure is not limited to the above-described example embodiments and may be changed as appropriate without departing from the spirit of the present disclosure.

Although the present disclosure has been described above with reference to example embodiments, the present disclosure is not limited to the above-described example embodiments. Various changes that can be understood by those skilled in the art can be made to the configuration and details of the present disclosure within the scope of the disclosure.

The whole or part of the example embodiments disclosed above can be described as, but not limited to, the following supplementary notes.

(Supplementary note 1)

A route display apparatus comprising:

an acquisition unit configured to acquire friend account information of a friend account that is connected online to an account of interest;

a specification unit configured to specify a traffic site near an activity site of a friend user who uses the friend account based on the acquired friend account information;

a calculation unit configured to calculate an estimated movement route of a user of interest who uses the account of interest, the estimated movement route including the specified traffic site; and

a display unit configured to display the calculated estimated movement route.

(Supplementary note 2)

The route display apparatus according to Supplementary note 1, wherein

the calculation unit calculates the estimated movement route having the traffic site near the activity site of the friend user as an end point.

(Supplementary note 3)

The route display apparatus according to Supplementary note 2, wherein

the specification unit specifies a traffic site near an activity site of the user of interest, and

the calculation unit calculates the estimated movement route connecting the traffic site near the activity site of the friend user to the traffic site near the activity site of the user of interest.

(Supplementary note 4)

The route display apparatus according to Supplementary note 2, wherein

the acquisition unit acquires first friend account information of a first friend account and second friend account information of a second friend account as the friend account information,

the specification unit specifies a traffic site near an activity site of a first friend user who uses the first friend account based on the first friend account information and specifies a traffic site near an activity site of a second friend user who uses the second friend account based on the second friend account information, and

the calculation unit calculates the estimated movement route connecting the traffic site near the activity site of the first friend user to the traffic site near the activity site of the second friend user.

(Supplementary note 5)

The route display apparatus according to any one of Supplementary notes 1 to 4, wherein the specification unit specifies the traffic site in accordance with a means of transportation of the user of interest.

(Supplementary note 6)

The route display apparatus according to any one of Supplementary notes 1 to 5, wherein the display unit displays image information captured in the estimated movement route.

(Supplementary note 7)

The route display apparatus according to any one of Supplementary notes 1 to 6, wherein the display unit displays posted information posted in the estimated movement route.

(Supplementary note 8)

The route display apparatus according to any one of Supplementary notes 1 to 7, wherein

the calculation unit calculates a plurality of estimated movement routes as the estimated movement routes, and

the display unit displays the plurality of estimated movement routes based on weighting of the plurality of estimated movement routes.

(Supplementary note 9)

A route display method comprising:

acquiring friend account information of a friend account that is connected online to an account of interest;

specifying a traffic site near an activity site of a friend user who uses the friend account based on the acquired friend account information;

calculating an estimated movement route of a user of interest who uses the account of interest, the estimated movement route including the specified traffic site; and

displaying the calculated estimated movement route.

(Supplementary note 10)

The route display method according to Supplementary note 9, wherein in the calculation of the estimated movement route, the estimated movement route is calculated using the traffic site near the activity site of the friend user as an end point.

(Supplementary note 11)

A route display program for causing a computer to:

acquire friend account information of a friend account that is connected online to an account of interest;

specify a traffic site near an activity site of a friend user who uses the friend account based on the acquired friend account information;

calculate an estimated movement route of a user of interest who uses the account of interest, the estimated movement route including the specified traffic site; and

display the calculated estimated movement route.

(Supplementary note 12)

The route display program according to Supplementary note 11, wherein in the calculation of the estimated movement route, the estimated movement route is calculated using the traffic site near the activity site of the friend user as an end point.

(Supplementary note 13)

A route display system comprising:

acquisition means for acquiring friend account information of a friend account that is connected online to an account of interest;

specification means for specifying a traffic site near an activity site of a friend user who uses the friend account based on the acquired friend account information;

calculation means for calculating an estimated movement route of a user of interest who uses the account of interest, the estimated movement route including the specified traffic site; and

display means for displaying the calculated estimated movement route.

(Supplementary note 14)

The route display system according to Supplementary note 13, further comprising storage means for holding the friend account information,

wherein the acquisition means acquires the account of interest information and the friend account information.

(Supplementary note 15)

The route display system according to Supplementary note 13, wherein the calculation means calculates the estimated movement route using the traffic site near the activity site of the friend user as an end point.

### REFERENCE SIGNS LIST

1 ROUTE DISPLAY SYSTEM
10 ROUTE DISPLAY APPARATUS
11 ACQUISITION UNIT
12 SPECIFICATION UNIT
13 CALCULATION UNIT
14 DISPLAY UNIT
20 COMPUTER
21 PROCESSOR
22 MEMORY
100 ROUTE DISPLAY APPARATUS
101 INPUT UNIT
102 COMMUNICATION UNIT
103 STORAGE UNIT
104 DISPLAY UNIT
105 SNS INFORMATION COLLECTION UNIT
106 ACTIVITY SITE EXTRACTION UNIT
107 TRAFFIC SITE SPECIFICATION UNIT
108 ROUTE CALCULATION UNIT
109 VIDEO IMAGE ACQUISITION UNIT
200 SNS SYSTEM
210 SNS SERVER
220 TERMINAL APPARATUS
230 DATABASE
300 INTERNET
400 MONITORING CAMERA

What is claimed is:

1. A route display apparatus comprising:
a memory storing instructions, and
a processor configured to execute the instructions stored in the memory to;
acquire friend account information of a friend account that is connected online to an account of interest;
specify a traffic site near an activity site of a friend user who uses the friend account based on the acquired friend account information;
calculate an estimated movement route of a user of interest who uses the account of interest, the estimated movement route including the specified traffic site; and
display the calculated estimated movement route.

2. The route display apparatus according to claim 1, wherein the processor is further configured to execute the instructions stored in the memory to calculate the estimated movement route having the traffic site near the activity site of the friend user as an end point.

3. The route display apparatus according to claim 2, wherein the processor is further configured to execute the instructions stored in the memory to;
specify a traffic site near an activity site of the user of interest, and
calculate the estimated movement route connecting the traffic site near the activity site of the friend user to the traffic site near the activity site of the user of interest.

4. The route display apparatus according to claim 2, wherein the processor is further configured to execute the instructions stored in the memory to;
acquire first friend account information of a first friend account and second friend account information of a second friend account as the friend account information,
specify a traffic site near an activity site of a first friend user who uses the first friend account based on the first friend account information and specify a traffic site near an activity site of a second friend user who uses the second friend account based on the second friend account information, and
calculate the estimated movement route connecting the traffic site near the activity site of the first friend user to the traffic site near the activity site of the second friend user.

5. The route display apparatus according to claim 1, wherein the processor is further configured to execute the instructions stored in the memory to specify the traffic site in accordance with a means of transportation of the user of interest.

6. The route display apparatus according to claim 1, wherein the processor is further configured to execute the instructions stored in the memory to display image information captured in the estimated movement route.

7. The route display apparatus according to claim 1, wherein the processor is further configured to execute the instructions stored in the memory to display posted information posted in the estimated movement route.

8. The route display apparatus according to claim 1, wherein the processor is further configured to execute the instructions stored in the memory to;
calculate a plurality of estimated movement routes as the estimated movement routes, and
display the plurality of estimated movement routes based on weighting of the plurality of estimated movement routes.

9. A route display method comprising:
acquiring friend account information of a friend account that is connected online to an account of interest;
specifying a traffic site near an activity site of a friend user who uses the friend account based on the acquired friend account information;
calculating an estimated movement route of a user of interest who uses the account of interest, the estimated movement route including the specified traffic site; and
displaying the calculated estimated movement route.

10. A non-transitory computer readable medium storing a program for causing a computer to:
acquire friend account information of a friend account that is connected online to an account of interest;
specify a traffic site near an activity site of a friend user who uses the friend account based on the acquired friend account information;
calculate an estimated movement route of a user of interest who uses the account of interest, the estimated movement route including the specified traffic site; and
display the calculated estimated movement route.
